(19) United States
(12) Patent Application Publication
(10) Pub. No.: US 2011/0036758 A1
(43) Pub. Date: Feb. 17, 2011

(54) ELECTROSTATIC SEPARATOR FOR UNBURNED CARBON FROM COAL ASH USING ELECTROSTATIC INDUCTION TYPE EJECTOR TRIBOCHARGER

(76) Inventors: Jae-kwan KIM, Daejeon (KR); Hyun-dong Lee, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/614,380

(22) Filed: Nov. 6, 2009

(30) Foreign Application Priority Data
Aug. 12, 2009 (KR) 10-2009-0074299

(51) Int. Cl. B03C 7/02; B03C 7/12

(52) U.S. Cl. 209/4

(57) ABSTRACT

The present disclosure relates to an electrostatic separator for separating unburned carbon from coal ash using an electrostatic induction type ejector tribocharger, which can be operated based on difference in electrostatic polarity between the coal ash and the unburned carbon mixed with each other to thereby significantly improve charges and separation efficiency according to the amount of coal ash.

### BACKGROUND OF THE INVENTION

1. Field of the Invention

The present invention relates to a separator for separating unburned carbon from coal ash generated in a coal fired power plant and, more particularly, to an electrostatic separator for separating unburned carbon from coal ash using an electrostatic induction type ejector tribocharger, which can be operated based on difference in electrostatic polarity between the coal ash and the unburned carbon mixed with each other to thereby significantly improve charges and separation efficiency according to the amount of coal ash.

2. Description of the Related Art

Coal fired plants or incinerators generate coal ash or incineration ash, which is highly valuable as concrete admixtures, light-weight construction fillers, filling materials, and the like.

However, since the coal ash generated from the coal fired plants generally contains a great amount (5˜20% by weight) of unburned carbon which obstructs recycling of the coal ash, it is necessary to separate the unburned carbon from the coal ash when using the coal ash for industrial purposes.

Among a variety of conventional processes for separating unburned carbon from coal ash, dry type processes includes a centrifugal separation process (also referred to as a particle size separation process) and a triboelectric charging type electrostatic separation process. The centrifugal separation process is based on the fact that large particles in coal ash contain a large amount of unburned carbon, and employs a supply classifier as a separator. However, when the content of unburned carbon is 5% or more in the coal ash, particle size screening becomes unsatisfactory and the unburned carbon is discharged along with fine particles formed by crushing coarse particles with impact, thereby making it difficult to recover fine fly ash containing 3 wt % or less unburned carbon therein from the raw ash.

Further, in the triboelectric charging type electrostatic separation process, particles are charged by contact between particle mixtures and an inner surface of a charger, followed by separation according to polarities thereof in an electric field. For this process, there are two methods, namely, a method of moving coal ash into a metal pipe using air or a method of installing a separate spiral metal member in a circular pipe.

In such an electrostatic separation process, coal ash is charged and is transferred to an electrostatic separator where the charged coal ash is separated according to polarities thereof. Thus, triboelectric charging efficiency is very important in the electrostatic separation process. In the conventional electrostatic separation process, however, the contact surface area between the particles of the coal ash and the tribocharger is decreased as the amount of coal ash is increased, so that a pure charging rate is lowered, thereby obstructing an increase in capacity of the electrostatic separation process. Further, in order to increase efficiency in triboelectric charging the particles, there is a need for a selective charging method, that is, a method of increasing the charging efficiency through contact with particles.

On the other hand, Korean Patent No. 333,894 discloses a fine particle separator based on the triboelectric charging type electrostatic separation process described above and is obtained by improving the conventional technique as mentioned above.

### SUMMARY OF THE INVENTION

The present invention is directed to solving the problems of the related art, and an aspect of the invention is to provide an electrostatic separator for separating unburned carbon from coal ash using an electrostatic induction type ejector tribocharger, which can recover fly ash with uniform quality by adjusting intensity of an electric field according to an amount of coal ash using electrodes for electrostatic induction disposed in the tribocharger to maintain uniform charges of the coal ash, so that triboelectric charges and electrostatic separation efficiency can be prevented from being decreased when the amount of coal ash increases.

According to an aspect, the invention provides an electrostatic separator for separating unburned carbon from coal ash using an electrostatic induction type ejector tribocharger, including: a coal ash supply unit including a hopper storing coal ash, a hopper rotary feeder connected to the hopper, a vibrator connected to the hopper rotary feeder and transferring the coal ash, a blower allowing the coal ash to be supplied in a proper amount at each time by the vibrator, an electrostatic induction type tribocharger having a coal ash-pressing nozzle designed according to a Venturi-tube principle, a blower air-amount measurer for injecting propulsion air into the tribocharger, a transfer tube through which particles charged by the tribocharger are supplied to an electrostatic separation unit, a distributor for dispersing the particles transferred through the transfer tube, and a distributor slit allowing the charged particles dispersed by the distributor to be supplied at a uniform flow rate to the electrostatic separation unit; the electrostatic separation unit including positive and negative electrode plates disposed in parallel to each other to apply a uniform electric field to the coal ash supplied through the distributor and a yield rate adjusting plate made of an insulating material and adjusting a yield rate; a collected particle rapping device for removing a particle layer collected on the electrode plates; and a fly ash collection unit including an exterior case of the electrostatic separation unit for preventing leakage of external high voltage, a funnel-shaped ash recovery section for preventing generation of vortex and guiding uniform flow rate distribution within the electrostatic separation unit, a duct for forming and transferring a mixture of air and the particles discharged from the recovery section, a fly ash collecting cyclone for collecting separated coal ash, and a waste collecting cyclone, wherein the coal ash supplied through a coal ash suction unit is subjected to mixing with air injected through the pressing nozzle, electrostatic induction and triboelectric charging in the tribocharger, and wherein the tribocharger includes a negative electrode plate connected to a power supply, a positive electrode connected to the ground and separated a constant distance from the negative electrode to maintain uniform intensity of the electric field, an upper plate disposed on the negative electrode plate, a lower plate disposed under the positive electrode plate, and an intermediate plate between the upper and lower plates to maintain the electrode plates, the upper, intermediate and lower plates insulating the negative and positive plates and being formed of a Teflon insulation material, and the positive and negative electrode plates being maintained at 5˜25 kV/cm to prevent air insulation failure.

### BRIEF DESCRIPTION OF THE DRAWINGS

FIG. 1 is a diagram of an overall process for separating unburned carbon from coal ash in accordance with one embodiment of the present invention;

FIG. 2 is a cross-sectional view of an ejector tribocharger as a main component of an electrostatic separator in accordance with one embodiment of the present invention;

FIG. 3 is an enlarged cross-sectional view taken along line I-I of FIG. 2;

FIG. 4 is an enlarged cross-sectional view taken along line II-II of FIG. 2;

FIGS. 5(A) and (B) are a cross-sectional view and a plan view of an electrostatic induction electrode shown in FIG. 2;

FIG. 6 is a graph depicting triboelectric charges of coal ash;

FIG. 7 is a graph depicting electrostatic separation efficiency of coal ash; and

FIG. 8 is micrographs for comparing raw ash with fly ash obtained by an electrostatic separator according to one embodiment of the present invention.

### DETAILED DESCRIPTION OF THE INVENTION

Embodiments of the invention will hereinafter be described with reference to the accompanying drawings.

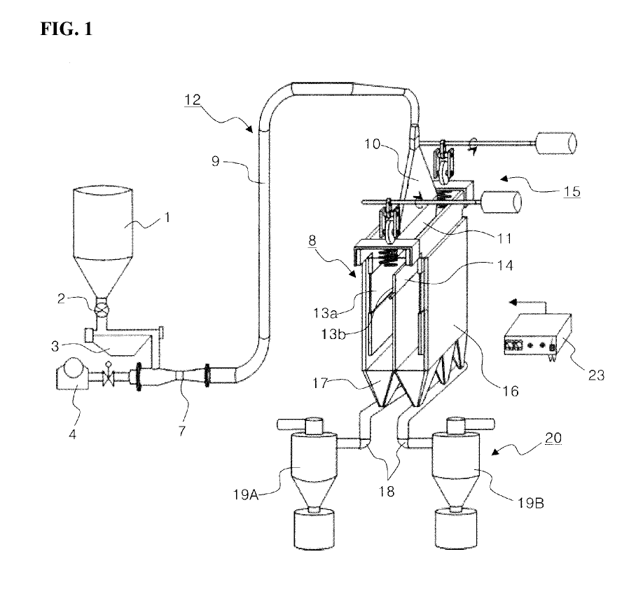

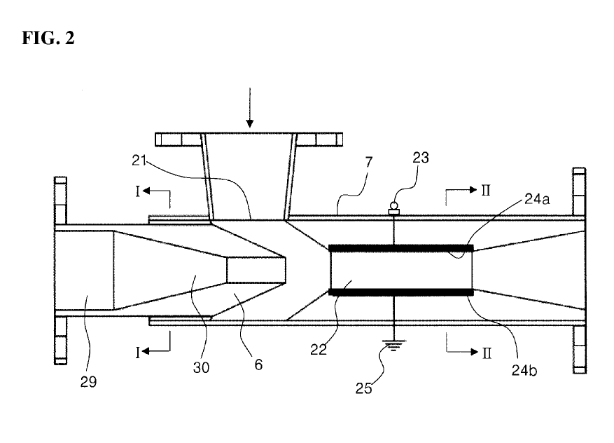

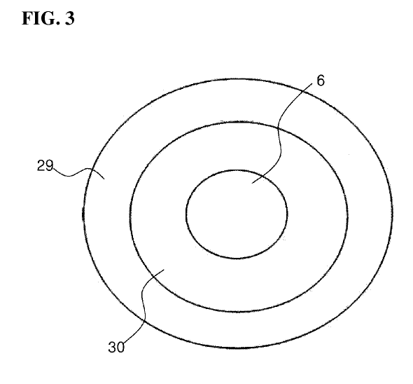

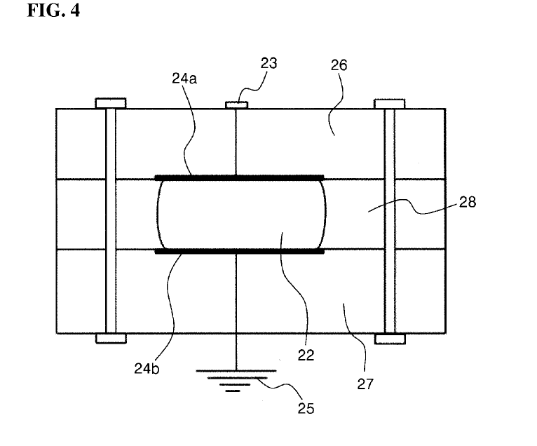

FIG. 1 is a diagram of an overall process for separating unburned carbon from coal ash in accordance with one embodiment of the invention, FIG. 2 is a cross-sectional view of an ejector tribocharger as a main component of an electrostatic separator in accordance with one embodiment of the invention, FIG. 3 is an enlarged cross-sectional view taken along line I-I of FIG. 2, and FIG. 4 is an enlarged cross-sectional view taken along line II-II of FIG. 2.

It should be noted that the present invention is obtained by modifying Korean Patent No. 333,894.

According to one embodiment, an electrostatic separator for separating unburned carbon from coal ash using an electrostatic induction type ejector tribocharger includes a coal ash supply unit 12, an electrostatic separation unit 8, a collected particle rapping device 15, and a fly ash collection unit 20.

The coal ash supply unit 12 includes a hopper 1 for storing coal ash, a hopper rotary feeder 2 connected to the hopper 1, a vibrator 3 which is connected to the hopper rotary feeder 2 and transfers the coal ash, a blower 4 which allows the coal ash to be supplied in a proper amount at each time by the vibrator 3, an electrostatic induction type tribocharger 7 which has a coal ash-pressing nozzle 6 designed according to a Venturi-tube principle, a blower air-amount measurer 5 which injects propulsion air into the tribocharger 7, a transfer tube 9 through which particles charged by the tribocharger 7 are supplied to the electrostatic separation unit 8, a distributor 10 which disperses the particles transferred through the transfer tube 9, and a distributor slit 11 which allows the charged particles dispersed by the distributor 10 to be supplied at a uniform flow rate to the electrostatic separation unit 8.

The electrostatic separation unit 8 includes positive and negative electrode plates 13a, 13b, which are disposed in parallel to each other to apply a uniform electric field to the coal ash supplied through the distributor 10, and a yield rate adjusting plate 14 which is made of an insulating material and adjusts a yield rate.

The rapping device 15 removes particle layers formed on the electrode plates 13a, 13b.

The fly ash collection unit 20 includes an exterior case 16 of the electrostatic separation unit 8 for preventing leakage of external high voltage, a funnel-shaped ash recovery section 17 which prevents generation of vortex and guides uniform flow rate distribution within the electrostatic separation unit 8, a duct 18 which forms and transfers a mixture of air and the particles discharged from the recovery section 17, a fly ash collecting cyclone 19A which collects refined fly ash, and a waste collecting cyclone 19B.

According to the embodiment, the coal ash supplied through a coal ash suction section 21 is sequentially subjected to mixing with air injected through the pressing nozzle 6, electrostatic induction, and triboelectric charging in the electrostatic induction type tribocharger 7. The tribocharger 7 has a triboelectric charging region 22, which is formed between a negative electrode plate 24a connected to a power supply 23 and a positive electrode 24b connected to the ground 25. The negative electrode plate 24a and the positive electrode 24b are separated a constant distance from each other in order to maintain uniform intensity of the electric field. The tribocharger 7 further includes an upper plate 26 disposed on the negative electrode plate 24a, a lower plate 27 disposed under the positive electrode plate 24b, and an intermediate plate 28 disposed between the upper and lower plates 26, 27 to maintain the electrode plates 24a, 24b. The upper, lower and intermediate plates 26, 27, 28 insulate the negative and positive plates 24a, 24b and are made of Teflon insulation material. The negative and positive plates 24a, 24b are maintained at 5˜25 kV/cm to prevent air insulation failure.

The positive and negative plates 24b, 24a of the tribocharger 7 are made of SUS 304, which is less wearable and has the coal ash and an intermediate work function to increase triboelectric charging efficiency of the coal ash and the unburned carbon. Therefore, the positive and negative electrode plates 24b, 24a guide selective charging of particles, that is, an increase in contact surface area between the particles and the metal, and allows fine particles of the unburned carbon crushed by contact charging and having positive polarity to be mixed with fine particles of the coal ash having negative polarity when transferred to the electrostatic separation unit 8.

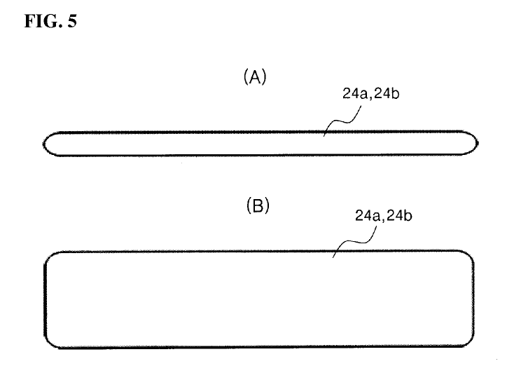

Further, as shown in (A) and (B) of FIG. 5, the positive and negative plates 24b, 24a of the tribocharger 7 have rounded corners and lateral sides to prevent failure of electric insulation and failure of electrostatic fields caused by electron movement in an electrostatic potential state.

### Example

Next, capacity of the electrostatic induction type tribocharger according to the embodiment of the invention will be described with reference to an example.

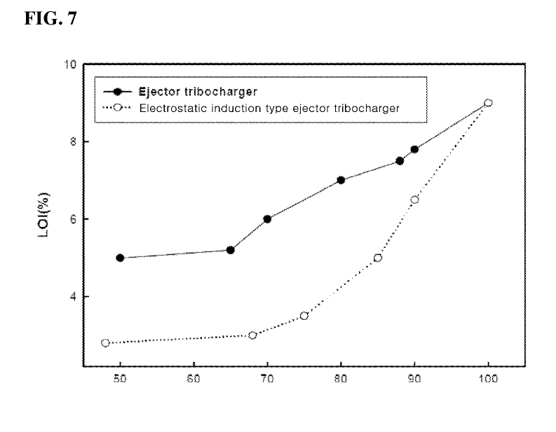

In the electrostatic induction type tribocharger 7 shown in FIG. 7, the coal ash suction section 21 has a diameter of 18.5 mm, an inlet 29 of the blower air-amount measurer has a diameter of 18.5 mm, and a neck 30 of the coal ash-pressing nozzle 6 has a diameter of 11.3 mm. The electrode plates 24a, 24b have the shape as shown in FIG. 5. Each of the electrode plates has a width of 17.4 mm, a length of 35 mm, and a thickness of 4 mm. A distance between the electrode plates 24a, 24b is 10 mm. The components of the electrostatic induction type tribocharger are disposed as shown in FIGS. 2 to 4.

Testing conditions were as follows.

propulsion amount of air at the inlet of the pressing nozzle: 2.12˜2.69 m³/min

intake amount of air at the inlet of the suction section: 3.18˜4.04 m³/min

flow rate in the electrostatic induction and triboelectric charging region: 500˜640 m/s

composition of coal ash: 1 kind of coal ash containing 9% unburned carbon
coal ash treatment capacity: 105˜330 kg/hr

intensity of electric filed in electrostatic induction type tribocharger: 10 kV/cm

The recovery rate of coal ash was measured using weight distribution of coal ash collected in the cyclone 19A and the content of unburned carbon was measured using a thermal analyzer. The result of analyzing test specimens is shown in Table 1.

TABLE 1
Weight distribution and cumulative distribution of coal ash
and amount of unburned carbon per particle size (in wt. %)

| | | Particle size distribution (μm) | | | | | | |
|---|---|---|---|---|---|---|---|---|
| Kind of Specimen | | +150 | 150~105 | 105~75 | 75~53 | 53~38 | 38~26 | −26 |
| 9% | Weight distribution | 2.8 | 3.9 | 4.6 | 5.5 | 5.8 | 6.4 | 71 |
| | Content of | 62.39 | 44.38 | 30.46 | 17.33 | 8.03 | 5.69 | 3.92 |
| | Unburned carbon | | | | | | | |

In Table 1, as the particle size of the coal ash decreased, the weight distribution of coal ash increased and the content of unburned carbon decreased. For coal ash containing 9% unburned carbon, the weight distribution was 71% and the content of unburned carbon was 3.92% at a particle size of 26 μm or less. In other words, it can be expected that when the coal ash is treated to have a particle size of 26 μm or less by centrifugal separation (particle size separation), highly pure fly ash containing 3% or less unburned carbon will not be obtained.

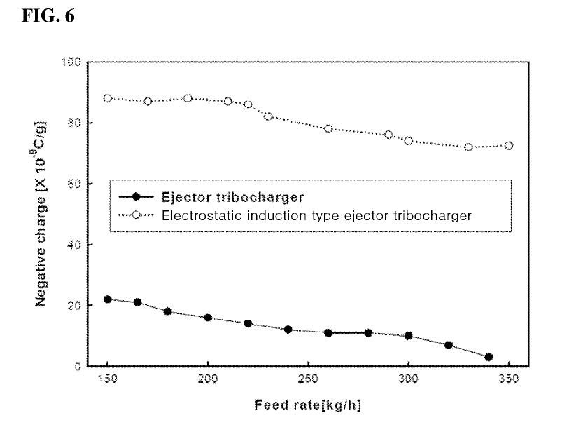

Under the testing conditions as above, negative charge of coal ash was significantly increased as much as four times or more after triboelectric charging through the electrostatic induction type tribocharger 7, to which electrostatic induction electrodes were provided as shown in FIG. 6, and an increase in amount of coal led to a slight decrease of charge.

Further, when using the electrostatic induction type tribocharger 7 as shown in FIG. 7, highly pure fly ash containing 3% unburned carbon could be recovered at a recovery rate of 68% or less. However, highly pure fly ash containing 3% unburned carbon could not be recovered by a conventional ejector tribocharger 7 even when the recovery rate is lowered to 50%.

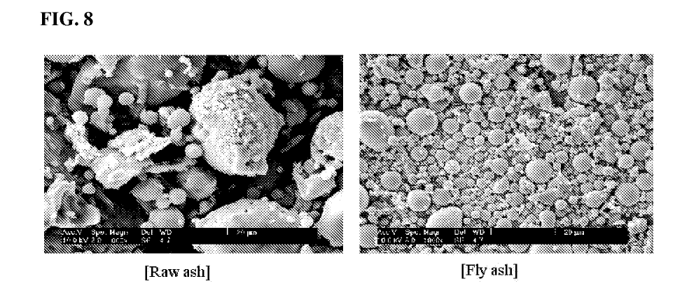

According to the invention, coarse particles are crushed into fine particles by triboelectric charging such that refined fly ash has much more uniform particle size than raw ash as shown in FIG. 8. Therefore, when recycled into, for example, admixtures for ready-mixed concrete, the refined fly ash enhances a filling rate of the concrete.

As such, according to the invention, the electrostatic separator for separating unburned carbon from coal ash solves performance deterioration of facilities relating to a capacity increase for purifying and recycling of coal ash and enhances separation efficiency.

Although some embodiments have been provided to illustrate the invention in conjunction with the drawings, it will be apparent to those skilled in the art that the embodiment is given by way of illustration only, and that various modifications, changes and substitutions can be made without departing from the spirit and scope of the invention, as defined only by the accompanying claims and equivalents thereof.

What is claimed is:

1. An electrostatic separator for separating unburned carbon from coal ash using an electrostatic induction type ejector tribocharger, the separator including: a coal ash supply unit including a hopper storing coal ash, a hopper rotary feeder connected to the hopper, a vibrator connected to the hopper rotary feeder and transferring the coal ash, a blower allowing the coal ash to be supplied in a proper amount at each time by the vibrator, an electrostatic induction type tribocharger having a coal ash-pressing nozzle designed according to a Venturi-tube principle, a blower air-amount measurer for injecting propulsion air into the tribocharger, a transfer tube through which particles charged by the tribocharger are supplied to an electrostatic separation unit, a distributor for dispersing the particles transferred through the transfer tube, and a distributor slit allowing the charged particles dispersed by the distributor to be supplied at a uniform flow rate to the electrostatic separation unit; the electrostatic separation unit including positive and negative electrode plates disposed in parallel to each other to apply a uniform electric field to the coal ash supplied through the distributor and a yield rate adjusting plate made of an insulating material and adjusting a yield rate; a collected particle rapping device for removing particle layers on the electrode plates; and a fly ash collection unit including an exterior case of the electrostatic separation unit for preventing leakage of external high voltage, a funnel-shaped ash recovery section for preventing generation of vortex and guiding uniform flow rate distribution within the electrostatic separation unit, a duct for forming and transferring a mixture of air and the particles discharged from the recovery section, a fly ash collecting cyclone for collecting separated coal ash, and a waste collecting cyclone,
wherein the coal ash supplied through a coal ash suction unit is subjected to mixing with air injected through the pressing nozzle, electrostatic induction, and triboelectric charging in the tribocharger, and
wherein the tribocharger includes a negative electrode plate connected to a power supply, a positive electrode connected to ground and separated a constant distance from the negative electrode to maintain uniform intensity of the electric field, an upper plate disposed on the negative electrode plate, a lower plate disposed under the positive electrode plate, and an intermediate plate between the upper and lower plates to maintain the electrode plates, the upper, intermediate and lower plates insulating the negative and positive electrodes and being formed of a Teflon insulation material, the positive and negative electrode plates being maintained at 5˜25 kV/cm to prevent air insulation failure.

2. The separator according to claim 1, wherein the positive and negative plates of the tribocharger are made of SUS 304 which is less subject to wear and has an intermediate work function and the coal ash to increase triboelectric charging efficiency of the coal ash and the unburned carbon.

3. The separator according to claim 1, wherein the positive and negative plates have rounded corners and lateral sides to prevent failure of electric insulation and failure of electrostatic fields caused by electron movement in an electrostatic potential state.
